(19) United States
(12) Patent Application Publication
(10) Pub. No.: US 2022/0335271 A1
(43) Pub. Date: Oct. 20, 2022

(54) INFORMATION PROCESSING APPARATUS, INFORMATION PROCESSING METHOD, AND NON-TRANSITORY COMPUTER READABLE MEDIUM

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Topon PAUL, Kawasaki (JP); Sreeharsha RAGHAVENDRA, Bangalore (IN)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 17/659,716

(22) Filed: Apr. 19, 2022

(30) Foreign Application Priority Data
Apr. 20, 2021 (JP) 2021-070913

(51) Int. Cl. G06N 3/04; G06N 3/08

(52) U.S. Cl. CPC G06N 3/04; G06N 3/08

(57) ABSTRACT

According to one embodiment, an information processing apparatus includes processing circuitry configured to group first variables in first data that includes the first variables and a second variable, and generate a plurality of groups that include the first variables; and determine a model architecture of a prediction model, based on the first data, the prediction model being configured to associate the first variables included in the groups with a predicted value of the second variable.

### CROSS REFERENCE TO RELATED APPLICATIONS

This application is based upon and claims the benefit of priority from the prior Japanese Patent Application No. 2021-070913, filed on Apr. 20, 2021, the entire contents of which are incorporated herein by reference.

### FIELD

Embodiment described herein relates to an information processing apparatus, an information processing method, and a non-transitory computer readable program.

### BACKGROUND

In the fields of weather forecast, extreme weather forecast, disaster prevention, renewable energy, hydroelectric power generation, stock price, risk analysis, and the like, the widely used practice is to predict the value (future value) of the objective variable after a certain period of time using current and past time-series data. For this purpose, a prediction model is constructed so as to minimize the error between predicted values and actual values in the entire interval of the time-series data. However, the problem of this approach is that the prediction model built in this way has large prediction errors at peak values, i.e., extreme values. Moreover, there is a tendency of prediction errors becoming larger for longer prediction periods at the peak values.

For the prediction of the water level of a dam, wind velocity, abnormal weather and the like, it is very important to accurately predict the peak value in order to prevent disaster. A model capable of accurately predicting the peak value can be built using a method based on deep learning. However, the deep learning-based model learns an enormous number of model parameters. Accordingly, it is required to collect many samples to build the model. When the number of collected samples is small, the prediction accuracy of the model decreases, which makes it difficult to accurately predict the peak values (extreme values). Furthermore, there is a tendency that increase in prediction period, in turn, increases the prediction error.

### BRIEF DESCRIPTION OF THE DRAWINGS

FIG. 1 is a block diagram of a prediction apparatus according to an embodiment;

FIG. 2 shows an example where the prediction accuracy of the peak value is low, and an example where the peak value can be accurately predicted;

FIG. 3 shows an example of time-series data on an objective variable and explanatory variables;

FIG. 4 shows an example of creating model input data using the cross-correlation between the explanatory variables and the objective variable;

FIG. 5 illustrates the cross-correlation;

FIG. 6 shows an example of creating model input data using a variable selection method;

FIG. 7 shows an example of creating model input data using a variable selection method;

FIG. 8 shows an example of a prediction model;

FIG. 9 shows an example of a model architecture of a prediction model using deep learning according to a comparative example;

FIG. 10 shows an example of a model architecture of a prediction model using deep learning according to this embodiment;

FIG. 11 shows an example of the number of input and output nodes in conformity with the model architecture;

FIG. 12 shows an example of calculating the number of parameters on each layer in conformity with the model architecture;

FIG. 13 shows a comparative example between the number of model parameters of deep learning according to the comparative example, and the number of model parameters of deep learning according to this embodiment;

FIG. 14 shows the relationship between the number of layers, data grouping, parameters (n), the number of model parameters, and the prediction accuracy;

FIG. 15 shows an example of time-series data;

FIG. 16 shows a first example of determining the model architecture;

FIG. 17 shows a second example of determining the model architecture;

FIG. 18 is a flowchart for generating the prediction model, and predicting the future value of the objective variable;

FIG. 19 is a flowchart for determining the data grouping of the model input data, and the model architecture;

FIG. 20 shows a GUI for determining the data grouping and the model architecture;

FIG. 21 shows an example of generating new variables;

FIG. 22 shows an example of generating new variables using genetic programming; and

FIG. 23 is a block diagram of an information processing apparatus according to an embodiment.

### DETAILED DESCRIPTION

According to one embodiment, an information processing apparatus includes processing circuitry configured to group first variables in first data that includes the first variables and a second variable, and generate a plurality of groups that include the first variables; and determine a model architecture of a prediction model, based on the first data, the prediction model being configured to associate the first variables included in the groups with a predicted value of the second variable.

Hereinafter, referring to the drawings, embodiments of the present invention are described. In the drawings, the same configuration elements are assigned the same numbers. The description is appropriately omitted.

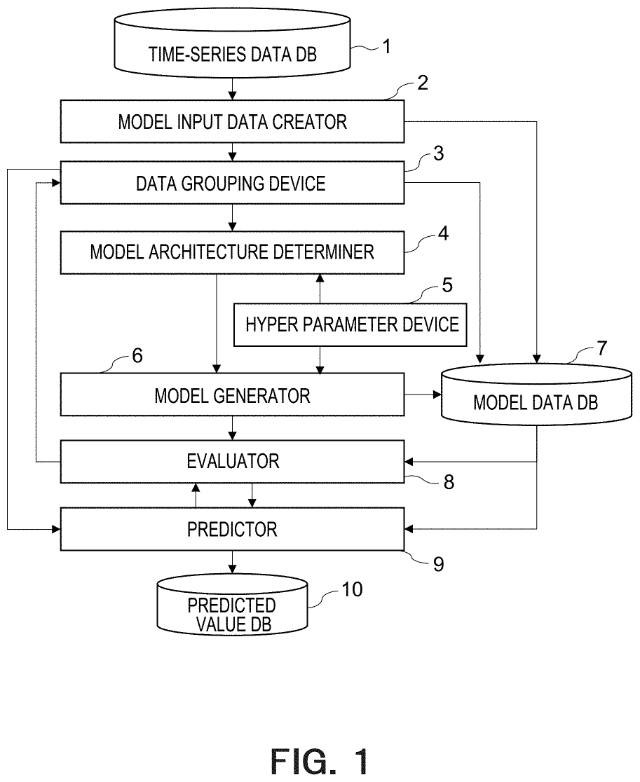

FIG. 1 is a block diagram of a prediction apparatus 101 that is an information processing apparatus according to this embodiment. The prediction apparatus 101 in FIG. 1 includes: a time-series data DB 1; a model input data creator 2 (data creator); a data grouping device 3 (grouping device); a model architecture determiner 4 (determiner); a hyper parameter device 5; a model generator 6; a model data DB 7; an evaluator 8; a predictor 9; and a predicted value DB 10. The model input data creator 2, the data grouping device 3, the model architecture determiner 4, the model generator 6, the evaluator 8 and the predictor 9 can be configured by processing circuitry as one example.

The prediction apparatus 101 in FIG. 1 is for accurately predicting the future values of an objective variable, based on time-series data including explanatory variables and the objective variable. For example, the prediction of the water level of a dam (prediction about a storage capacity for a hydraulic power plant), wind velocity prediction, abnormal weather forecast, risk analysis prediction, stock price prediction and the like are performed. According to the technical background of this embodiment, there is a problem in that objective variable prediction, in particular, prediction of a peak value (extreme value) is difficult. This embodiment allows the peak value of the objective variable to be accurately predicted.

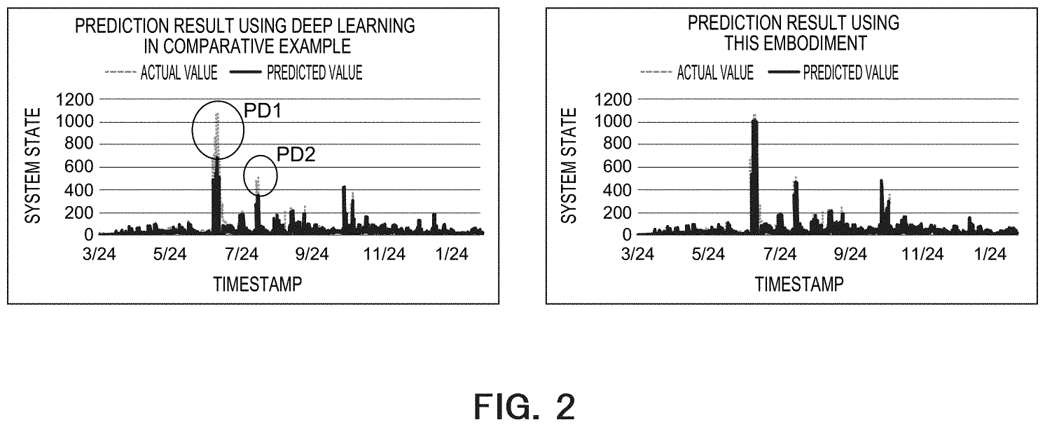

The left diagram in FIG. 2 shows an example where the prediction of the peak value is difficult. This example shows a prediction result using deep learning according to a comparative example. According to this case, the difference PD1 between the predicted value of the highest peak and the actual value, and the difference PD2 between the predicted value of a second highest peak and the actual value are both large. Accordingly, the accuracy of the prediction is low.

The right diagram in FIG. 2 shows an example where the peak value can be accurately predicted. The difference between the predicted value and the actual value is small at every peak, and a high prediction accuracy is achieved. The prediction result is obtained by deep learning according to this embodiment described later. This embodiment allows the peak value to be accurately predicted.

The time-series data DB 1 holds past and current time-series data items on the objective variable. The time-series data DB 1 holds past, current and future time-series data items on the objective variable. The future time-series data on the explanatory variable is time-series data on the predicted values of the explanatory variables. For example, in a case of dam inflow forecast, the predicted value of the explanatory variable may be a weather forecast value.

The time-series data DB 1 may only hold the time-series data of the objective variable, or hold time-series data of the objective variable and the explanatory variables. A time at a time point when the objective variable is predicted corresponds to the current time.

The time-series data DB 1 may not be time-series data on the explanatory variables and the objective variable in all the past intervals, but may only hold data in an interval where characteristic waveforms are represented.

The time-series data DB 1 holds a flag (identification flag) indicating whether the value of the objective variable and the values of the explanatory variables measured at each timestamp are of a model learning data (data for model learning) or a prediction data (data for prediction). The time-series data DB 1 may hold a flag (mode flag) of whether to execute a model learning process or a prediction process.

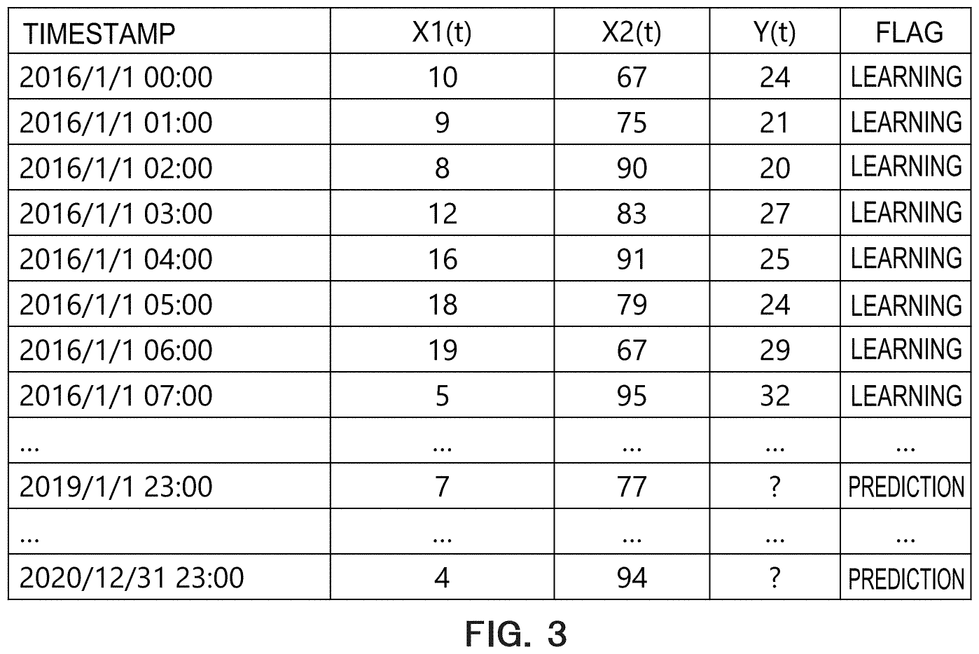

FIG. 3 shows an example of the time-series data of the objective variable and the explanatory variables held by the time-series data DB 1. “X1(t)” and “X2(t)” are explanatory variables and “Y(t)” is the objective variable. “X1(t)”, “X2(t)” and “Y(t)” have values of items different from each other. The timestamp is the date and time when the value of the objective variable and the values of the explanatory variables are measured. For the data items (the value of the objective variable and the values of the explanatory variables) at each timestamp, a flag (identification flag) indicating whether the data is model learning data or prediction data is set.

The model input data creator 2 creates model input data, based on the relationship between the objective variable and the explanatory variables, using the time-series data on the objective variable and the explanatory variables held by the time-series data DB 1.

When the model input data creator 2 executes the model learning process, this creator extracts the model learning data from the time-series data DB 1, based on the identification flag, and creates the model input data (first data) for model learning. When the model input data creator 2 executes the prediction process, this creator extracts the prediction data from the time-series data DB 1, based on the identification flag, and creates the model input data (first data) for prediction.

To create the model input data (first data), the model input data creator 2 uses the cross-correlation between the objective variable and the explanatory variables in the time-series data, the autocorrelation of the objective variable, mutual information content (MIC), AIC, LASSO, linear regression, a regression tree, or a variable selection method (e.g., genetic algorithm).

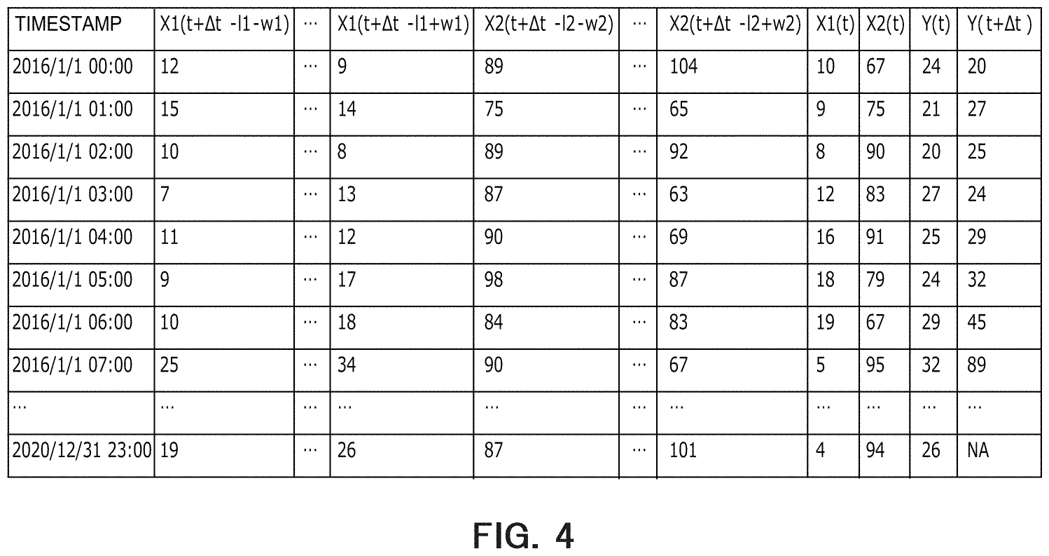

FIG. 4 shows an example of creating model input data using the cross-correlation between the explanatory variables and the objective variable. In this case, “t+Δt” is the target prediction time that indicates the time “Δt” step after each timestamp “t”. “Δt” corresponds to a prediction period or a prediction step. In the case of cross-correlation, a time lag (lag) having a high cross-correlation between the objective variable and the explanatory variables is found. Provided that the time lag is “lᵢ”, the time “lᵢ” before “t+Δt” is “t+Δt−lᵢ”. Past values of the explanatory variables at “2wᵢ+1” (“w”: window width) times that include the time concerned are extracted. The “2wᵢ+1” (“w”: window width) times are different times for the explanatory variables. These different times are times before the prediction target time “(t+Δt)”.

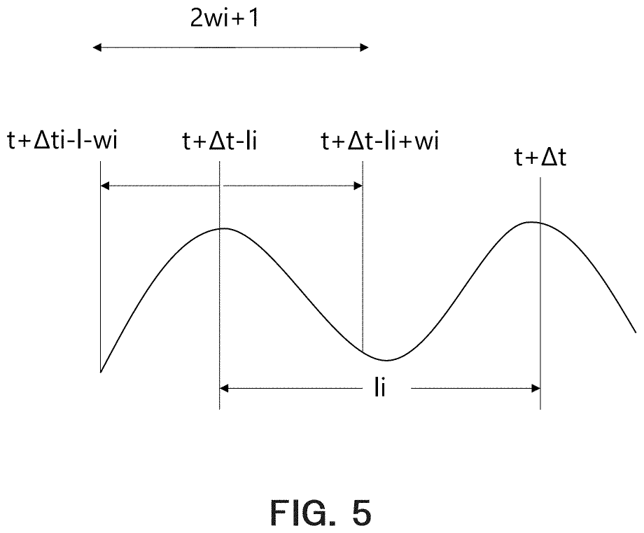

FIG. 5 shows an example of extracting the values of a certain explanatory variable at “2wᵢ+1” (“w”: window width) times. “t+Δt−lᵢ”, which is the time “lᵢ” before “t+Δt” is “t+Δt−lᵢ”, is identified. The total “2wᵢ+1” values of the explanatory variable at past “wᵢ” times and future “wᵢ” times including “t+Δt−lᵢ” are extracted.

In the example in FIG. 4 described above, for the explanatory variable X₁, a lag of “l₁” is calculated as the cross-correlation with the objective variable. Accordingly, the total “2w₁+1” values of past “w₁” times and future “w₁” times including “t+Δt−l₁” are extracted. That is, in the case of the explanatory variable X₁, the data on the model input data at each timestamp is “X₁(t+Δt−l₁−w₁), . . . , X₁(t), X₁(t+Δt−l₁+w₁)”.

Likewise, for the explanatory variable X₂, a lag of “l₂” is calculated as the cross-correlation with the objective variable. Accordingly, the total “2w₂+1” values of past “w₂” times and future “w₂” times including “t+Δt−l₂” are extracted. That is, in the case of the explanatory variable X₂, the data on the model input data at each timestamp is “X₂(t+Δt−l₂−w₂), . . . , X₂(t), X₂(t+Δt−l₂+w₂)”. Note that if no predicted value of the explanatory variable exists, only past values are used. In this case, “Δt=0” and −lᵢ+wᵢ=min(0, −lᵢ+wᵢ). The values of w₁ and w₂ are preset. “min(a, b)” is a function indicating the smaller one of “a” and “b”.

Furthermore, the value of the current time “t” for the explanatory variables “X₁ and X2”, the value of the current time “t” for the objective variable “Y”, and the value of the objective variable at a time “(t+Δt)”, which is “Δt” time thereafter, are extracted.

As described above, the model input data (data on one line in the table of FIG. 4) for one timestamp is created. Likewise, for a plurality of timestamps, the model input data is created. The data for one timestamp corresponds to one sample of the model input data. The timestamp for each sample corresponds to the current time “t”. Note that a configuration that does not include “Y(t)” in the model input data can also be achieved.

A plurality of variables other than “Y(t+Δt)” correspond to first variables in the model input data (first data). The value at the current time “t” (“Y(t)” in the example in FIG. 4) also corresponds to the first variable in the model input data. “Y(t+Δt)” corresponds to a second variable of the model input data. The time (t+Δt) corresponds to the prediction target time. “Y(t)” is an example of the objective variable at a time before the prediction target time. “Y(t−1), Y(t−2) . . . ” and the like are extracted as the first variable using the autocorrelation of the objective variable, in some cases. “Y(t+Δt)” is an example of the second variable in the model input data. There may be a plurality of the second variables. For example, in the case of Δt=5, “Y(t+1), Y(t+2), Y(t+3), and Y(t+4)” may be further set as the second variables (corresponding to the objective variables of the prediction model).

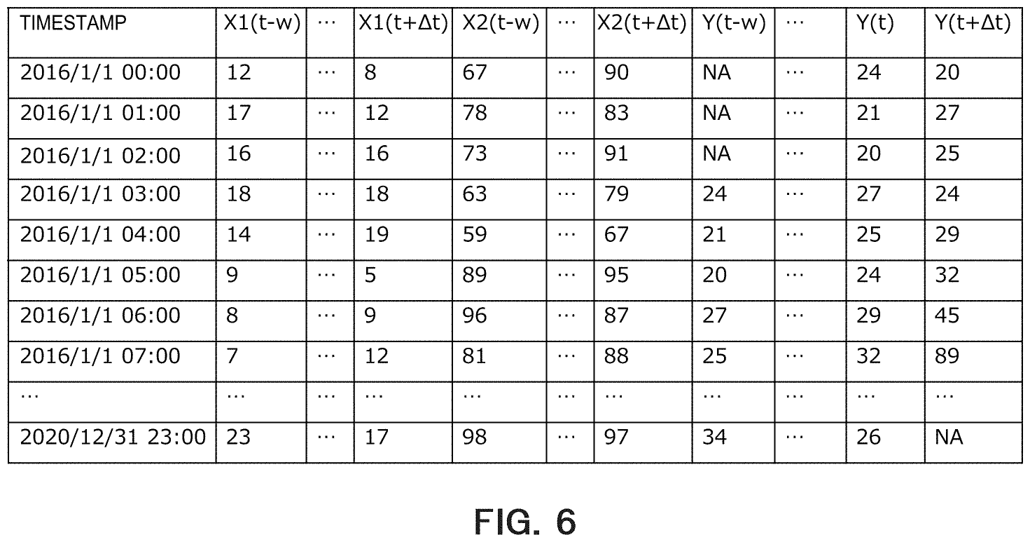

FIG. 6 shows an example of creating the model input data (first data) using the variable selection method. In this example, when a predicted value of the objective variable exists, the values of the explanatory variables at times from a time “t−w”, which is the window width—“w”—before time “t”, to “t+Δt”, and the values of the objective variable at times from a time “t−w”, which is the window width—“w”—before time “t”, to “t” and at a time “(t+Δt)”, which is “Δt” time thereafter, are used, and temporary model input data (interim model input data) is created. FIG. 6 shows an example of the created temporary model input data. A plurality of variables other than “Y(t+Δt)” correspond to first variables in the temporary model input data. The values “(Y(t)) . . . Y(t−w)” and the like at the current time “t” also correspond to the first variables in the model input data. “Y(t+Δt)” corresponds to a second variable of the temporary model input data.

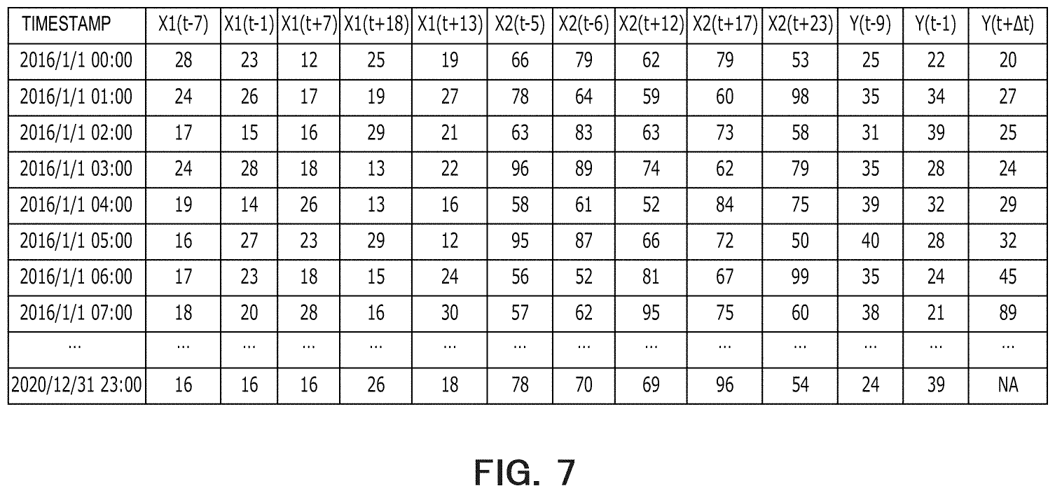

FIG. 7 shows an example of the temporary model input data created when the values of the window width “w” are set as different values with respect to each of the explanatory variables “X1, X2” and the objective variable “Y”. “Y(t+Δt)” corresponds to a second variable of the temporary model input data. The variables other than “Y(t+Δt)” correspond to the first variables in the temporary model input data.

The model input data creator 2 selects important first variables from the temporary model input data using the mutual information content (MIC), AIC, LASSO, linear regression, regression tree, or variable selection method. The model input data creator 2 may include a variable selector that selects variables. In the case of using the LASSO, linear regression or regression tree, a temporary prediction model for predicting the second variable (corresponding to the objective variable of the temporary prediction model) is created using the temporary model input data, and the first variables are selected using the coefficients of the first variables included in the temporary prediction model. For example, a plurality of first variables having a larger absolute value of the coefficient are selected. The model input data is created using the values of the selected first variables, and the values of the second variable. The selected first variables correspond to the explanatory variables of the temporary prediction model, and the second variable corresponds to the objective variable of the temporary prediction model. The explanatory variables and the objective variable in the time-series data, and the explanatory variables and the objective variable in the temporary prediction model do not necessarily match each other. For example, the objective variable of the time-series data before the current time “t” can correspond to the explanatory variable of the temporary prediction model.

The data grouping device 3 groups the variable (first variable) included in the model input data created by the model input data creator 2, and generates one or more data groups (a method of dividing the first variable into a plurality of data groups is called data grouping). The data grouping device 3 may divide the variable into the data groups according to previous knowledge, or may randomly divide the variable (first variable) and generate a plurality of data groups. Alternatively, the division into the data groups may be made through cooperation between the model input data creator 2 and the model architecture determiner 4.

In the case where the variable (first variable) is divided into the data groups according to the previous knowledge, the variable of the model input data may be divided into three data groups that are a past data group (second group), a current data group (first group), and a future data group (third data group). In the case the variable is randomly divided, the number of data groups may be determined and the variables of the model input data may be randomly allotted to each group. The data grouping device 3 cooperates with the model architecture determiner 4 may generate a plurality of data grouping candidates so as to generate a model architecture of a prediction model capable of accurate prediction, and select a grouping candidate capable of generating the model architecture.

The model architecture determiner 4 determines the model architecture of the prediction model capable of accurate prediction, using the data group obtained by dividing the variable (first variable) by data grouping determined by the data grouping device 3. The model architecture defines the model type or the function type. For example, in a case where the model is multi-layered neural network, the definition includes the type and number of layers, and the number of nodes included in each layer. This will be described later.

The hyper parameter device 5 determines the value of the hyper parameter of the model. For example, in a case of deep learning, “activation” function, the batch size, the number of epochs, loss function, and an optimization method and the like are determined, as hyper parameters. For example, the hyper parameter device 5 stores these values, and uses the stored values. Alternatively, the hyper parameter device 5 may obtain the values of the hyper parameters from a user who is an operator of this apparatus, through the input device, and use the obtained values. Note that the hyper parameters are parameters that are predetermined when learning is performed.

The model generator 6 generates (learns) the prediction model, based on the model learning data according to the data grouping, and on the model architecture determined by the model architecture determiner 4. A method based on deep learning, a method based on a typical neural network (feed forward neural network) or the like is used as the model learning method. The method based on deep learning uses a multi-layered neural network. The method is an example of a method through a regression model. A method based on another regression model may be used. For example, a method of combining a linear regression (or multiple regression) for each data group, with ensemble learning adopting the output value of each linear regression as a member, may be used. This embodiment is described using the method based on deep learning. The first variables included in the prediction model correspond to the explanatory variables of the prediction model, and the second variable of the prediction model corresponds to the objective variable of the prediction model. Accordingly, the explanatory variables and the objective variable in the time-series data, and the explanatory variables and the objective variable in the prediction model do not necessarily match each other. For example, the objective variable of the time-series data before the current time “t” can correspond to the explanatory variable (first variable) of the prediction model.

The model generator 6 may weight each sample (the model input data at each timestamp; i.e., a line of the model input data), according to the value of the second variable (objective variable) of the model input data. For example, the model generator 6 may classify the model input data into a plurality of classes and apply different weights to the model input data (sample) on a class-by-class basis, through comparison between the value of the second variable (objective variable) of the model input data and a threshold, and generate a prediction model (i.e., learn model parameters). For example, samples having the value of the objective variable (second variable) equal to or more than the threshold are regarded to correspond to a peak portion, and are assigned a first weight. Samples having the value of the objective variable (second variable) less than the threshold are regarded to correspond to a non-peak portion, and are assigned a second weight lower than the first weight. The model generator 6 may assign each sample the output of the function as the weight, using a function that receives, as inputs, the values of the objective variable of the model input data.

The model data DB 7 holds information (variable information) about the variable included in the model input data created by the model input data creator 2, information about the prediction model generated by the model generator 6 (model information; e.g., the value of the model parameter included in the prediction model), information about data grouping output from the data grouping device 3 (data grouping information), and information about the model architecture determined by the model architecture determiner 4 (model architecture information).

Specifically, the variable information includes variables (first variables and the second variable) included in the model input data created by the model input data creator 2. In a case where the variable is represented by a function, the function may be held. In the case where the variables (first variables) are selected by the variable selection method, information on the variable selection method may be included in the variable information.

The data grouping information includes the number of data groups, and information on the variables (first variables) belonging to each data group.

In the case of deep learning, the model architecture information includes the layer information, the number of layers, and the number of nodes on each layer in the neural network (model).

The model information includes hyper parameter information, the parameter values of the model (e.g., the weight of connection between nodes, and a bias value). The model information may include the model architecture information.

The evaluator 8 calculates the predicted value for each sample (model input data) using the prediction model and the model input data for model learning, and calculates the evaluation score of the prediction model, based on the difference between the actual value and the predicted value of the sample. For example, the value of “Y” at “t+Δt” is predicted using the variables (the first variables and the second variable) included in the prediction model among variables (the first variables and the second variable) included in the first sample of the model input data in FIG. 6. The difference between the predicted value and the value “Y(t+Δt)” of the second variable of the first sample is calculated. Also for another sample, the difference is calculated in a similar manner.

Based on the differences calculated for multiple samples, the evaluation score is calculated. Any of the root mean square error (RMSE), determination coefficient (R²), mean absolute error (MAE), and mean absolute percentage error (MAPE) can be used as the evaluation score.

The evaluator 8 generates the prediction model for each of combinations between one or more pieces of data grouping and one or more model architectures, and the evaluation score is calculated. Based on the calculated evaluation score, the best pair between the data grouping and the model architecture (the pair having the highest evaluation score) is determined. A prediction model generated in association with the determined pair is adopted as the best prediction model.

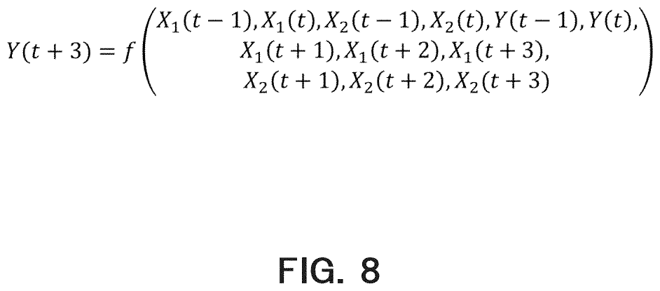

FIG. 8 shows an example of the prediction model. A function “f” is a function of performing a process in conformity with the model architecture. The variables in the function “f” correspond to the first variables (the explanatory variables of the prediction model). “Y(t+3)” corresponds to the second variable (the objective variable of the prediction model). In this case, “Δt=3”.

The predictor 9 calculates the predicted value of the second variable (the objective variable of the prediction model), using the model input data for prediction, and the prediction model generated by the model generator. The model input data creator 2 identifies data having the flag (identification flag) indicating “PREDICTION”, in the time-series data in the time-series data DB 1, and creates the model input data for prediction, using the variables (the first variables used in the prediction model) indicated by the variable information, in the identified data. The variables (first variables) included in the model input data for prediction are grouped, using the data grouping information. The predicted value of the objective variable (second variable) is calculated using the variables (first variables) of each data group and the generated prediction model (i.e., model parameters).

The predicted value DB 10 stores the predicted value (the future value of the predicted objective variable) calculated by the predictor 9, in association with the time for prediction target (the prediction target time or the timestamp).

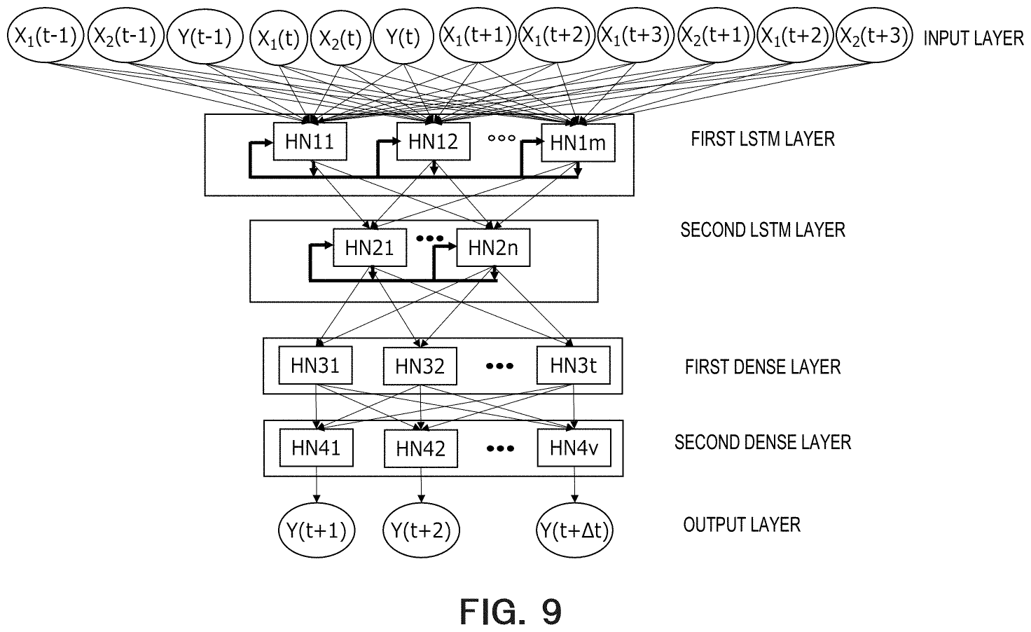

FIG. 9 shows an example of a model architecture of prediction model creation using deep learning according to a comparative example. In this example, this model architecture includes an input layer, an output layer, and intermediate layers. The intermediate layers include two types of layers that are two LSTM (Long Short Term Memory; long and short memory) layers, and two dense layers (high density layers). All the variables (first variables) of the model input data are outputs from the nodes (input nodes) on the input layer, and serve as inputs to hidden nodes to the first LSTM layer. The outputs from the hidden nodes on the first LSTM layer serve as the inputs to hidden nodes on the second LSTM layer. The outputs from the hidden nodes on the second LSTM layer serve as the inputs to hidden nodes on the first dense layer. The outputs from the hidden nodes on the first dense layer serve as the inputs to hidden nodes on the second dense layer. The outputs from the hidden nodes on the second dense layer serve as the inputs to nodes (output nodes) on the output layer. The outputs from the output nodes serve as predicted values.

In the case of the LSTM layer, the number of model parameters to be learned is obtained using the following Expression (1). Note that also in a case where an RNN (Recurrent Neural Network) layer or a GRU (Gated Recurrent Unit) layer is used, the number of model parameters to be learned is similarly obtained using the following Expression (1).

[Expression 1]

P=g(hm+h²+h) (1)

where “m” is the number of input nodes (or the number of nodes on the input source layer), “h” is the number of hidden nodes (or the number of nodes for output to the next layer), and “g” is the number of gates. In the case of the LSTM layer, “g” is four. Note that in the case of the RNN layer, “g” is one. In the case of the GRU layer, “g” is three.

In the cases of the first and second dense layers, the number of model parameters to be learned is obtained using the following Expression (2).

[Expression 2]

P=h(m+1) (2)

where “m” is the number of input nodes (or the number of nodes on the input source layer), and “h” is the number of hidden nodes (or the number of nodes for output to the next layer).

On the other hand, in a case of using a typical feed forward neural network, the number of parameters to be learned is obtained using the following Expression (3).

[Expression 3]

P=h(m+o)+(h+o) (3)

where “m” is the number of input nodes (or the number of nodes on the input source layer), “h” is the number of hidden nodes (or the number of nodes for output to the next layer), and “o” is the number of output nodes.

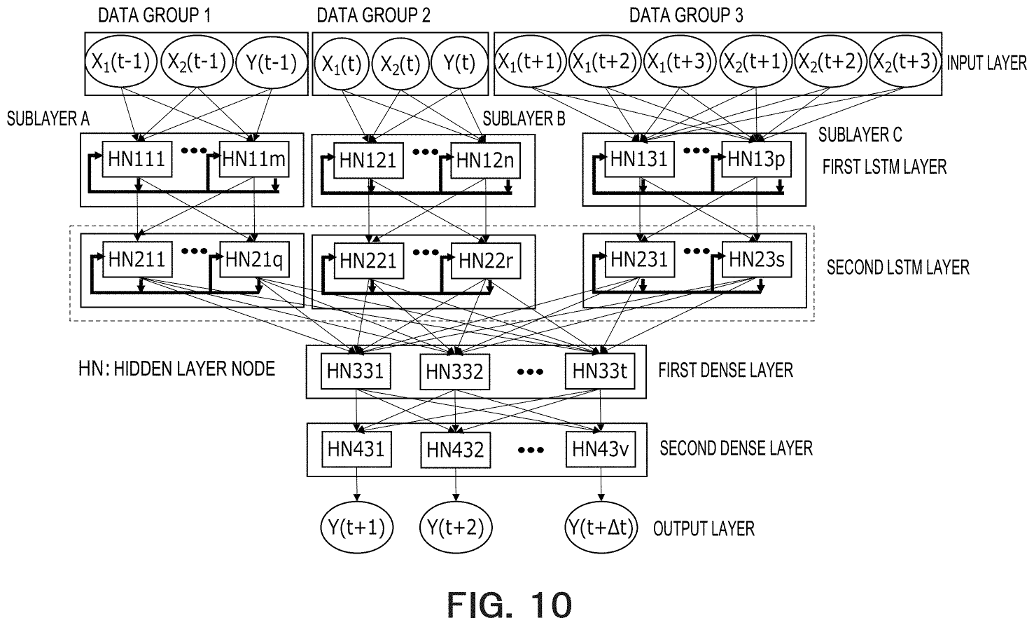

FIG. 10 shows an example of a model architecture of prediction model generation using deep learning according to this embodiment. In this example, as in the deep learning according to the comparative example, the two LSTM (Long Short Term Memory) layers and two dense layers are used. The first LSTM layer and the second LSTM layer each include a plurality of sub-LSTM layers (sub-models) according to the number of data groups. The sub-LSTM layers on the second LSTM layer are merged, and the outputs from the merged sub-LSTM layers serve as the inputs of the first dense layer. Use of the model architecture in this embodiment divides the variables (first variables) of the model input data into the data groups, which achieves an advantageous effect of reducing the model parameters to be learned. Note that in the example in FIG. 10, the plurality of second variables (the objective variables of the prediction model), “Y(t+1), Y(t+2) . . . Y(t+Δt)”, are present. However, the number of objective variables of the prediction model is one in some cases.

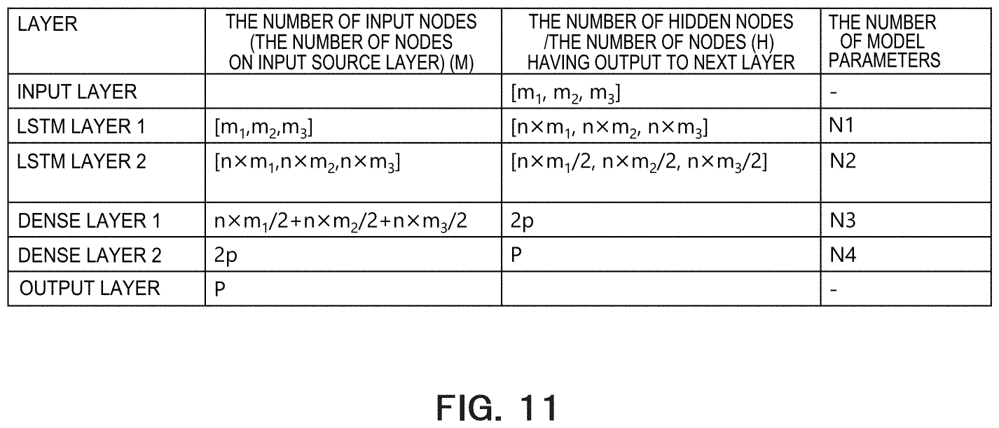

FIG. 11 shows an example of the number of input nodes (the number of nodes on the input source layer), the number of hidden nodes (the number of nodes for output to the next layer), and the number of model parameters to be learned, for each layer in conformity with the model architecture.

The example in FIG. 11 assumes a case where the variables (first variables) are divided into a past data (lag data) group, a current data group, and a future data (lead data) group. “m₁” is the number of variables of the past data group, “m₂” is the number of variables of the current data group, and “m₃” is the number of variables of the future data group.

Two LSTM layers (LSTM layer 1 and LSTM layer 2), and two dense layers (dense layer 1 and dense layer 2) are used. In FIG. 11, the number of nodes on the LSTM layer 2 is half the number of nodes on the immediately previous LSTM layer 1. Likewise, the number of nodes on the dense layer 2 is half the number of nodes on the immediately previous dense layer 1. Also in cases where the number of nodes on the LSTM layer is three or more, the number of nodes on the LSTM layer may be half the number of nodes on the immediately previous LSTM layer. Also in cases where the number of nodes on the dense layer is three or more, the number of nodes on the dense layer may be half the number of nodes on the immediately previous dense layer. Note that “half” is only an example. A different ratio may be used instead.

The parameter (n) is a parameter about determination of the number of nodes on the LSTM layer (the-number-of-nodes-related parameter). The number of nodes on the first LSTM layer is determined according to the parameter (n), and then the number of nodes on the second LSTM layer is determined to be half or the like of the number of nodes on the first LSTM layer. According to the value of the parameter (n), the number of nodes on the LSTM layer varies. According to the value of the parameter (n), the number of model parameters to be learned on each layer varies. The calculation of the number of nodes on each layer shown in FIG. 11 is only one example. Determination may be made by another method. The parameter (n) may be different among the data groups.

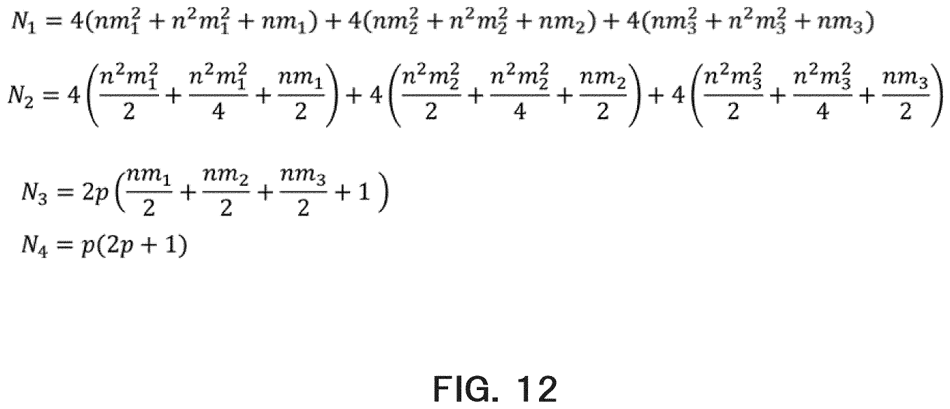

FIG. 12 shows a specific example of calculation of the number of model parameters to be learned on each layer according to the model architecture, based on the example in FIG. 11. Calculation examples are shown that include the number of model parameters learned on the first LSTM layer is “N1”, the number of model parameters learned on the second LSTM layer is “N2”, the number of model parameters learned on the first dense layer is “N3”, and the number of model parameters learned on the second dense layer is “N4.

To generate (learn) an accurate prediction model, the number of samples of the model input data equal to or more than N1+N2+N3+N4 (“+” means addition) are required. For example, in a case where the number of samples is 150,000, the number of variables of the past data group is m₁=9, the number of samples of the current data group is m₂=3, the number of variables of the future data group is m₃=12, and the number of variables on the output layer is p=12, the parameter (n) is nine or less. Under a condition (a condition of the number of samples) where the number of samples is N1+N2+N3+N or more, the number of nodes on each layer can be determined according to the number of samples of the model input data. Accordingly, irrespective of the number of samples (even with a small number of samples), an accurate prediction model can be generated. That is, a model architecture capable of generating an accurate prediction model can be determined, and a prediction model having the determined model architecture can be generated.

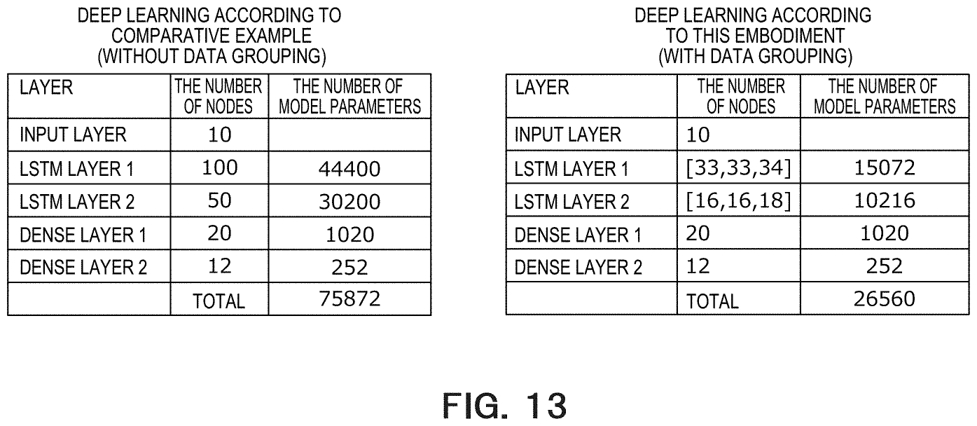

FIG. 13 shows the number of model parameters of deep learning according to the comparative example, and the number of model parameters of deep learning according to this embodiment. The number of model parameters of deep learning according to this embodiment is about one third of the number of model parameters of deep learning according to the comparative example. In this embodiment, when the number of samples is 26,560 or more, an accurate prediction model can be learned. However, in the case of the deep learning according to the comparative example, 75,872 or more of samples are required to learn an accurate prediction model.

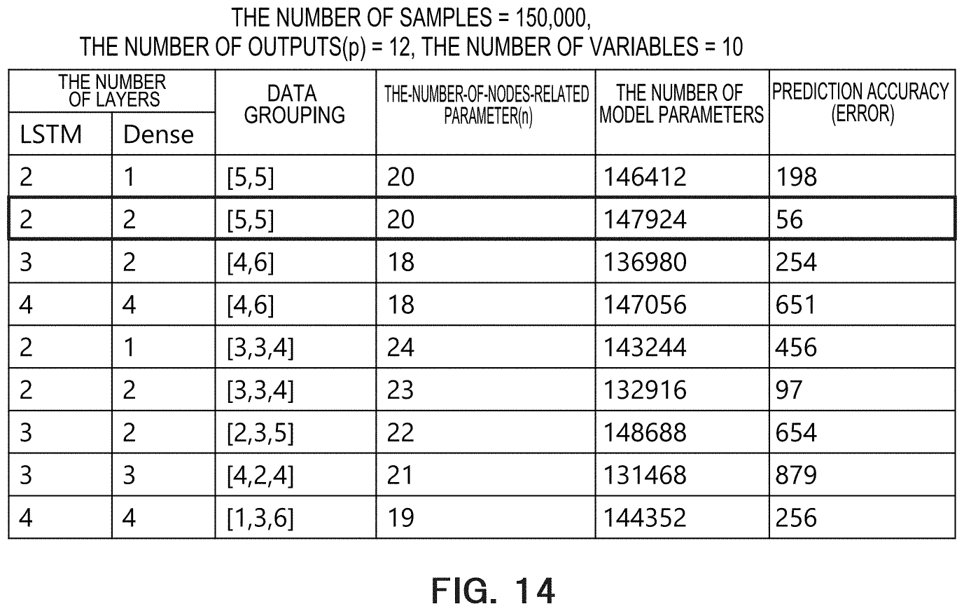

FIG. 14 shows an example of determining the number of layers of deep learning, the number of data groups, and the-number-of-nodes-related parameter (n), when the number of samples of the model learning data is 150,000, the number of variables (first variables) used in the prediction model is 10, and the number of variables (second variables) in the prediction model, i.e., the number of outputs (the number of prediction step) is 12.

First, the number of layers for each type of the intermediate layer of deep learning and the number of data groups are combined with the-number-of-nodes-related parameters (n), and a plurality of candidates are created, and the prediction model is created for each candidate through model learning by the model generator 6. The evaluator 8 evaluates the prediction model, and calculates the evaluation score. The evaluator 8 selects the candidate that achieves the best evaluation score or an evaluation score less than the threshold from among the candidates. Note that any of configurations can be adopted where the larger the value is, the higher the evaluation is and where the smaller the value is, the higher the evaluation is, according to the definition of the evaluation score. In this embodiment, the case where the smaller the value is, the higher the evaluation is dealt with.

According to this example, a candidate is selected where the number of LSTM layers is two, the number of dense layers is two, the number of data groups is two (each of the numbers of variables of two data groups is five), and the-number-of-nodes-related parameters (n) is 20. That is, the (ten) variables of model input data items are halved into two data groups. The model architecture including two LSTM layers and two dense layers is constructed. The numbers of nodes on these layers are determined using the-number-of-nodes-related parameters (n). For example, the number of nodes for each layer can be determined to large as much as possible, within a range of satisfying the condition of the number of samples described above. The evaluation score of the prediction model generated in this case is 56. This value is a best prediction accuracy (error) among the candidates. The number of model parameters in the selected candidate (the total of the number of model parameters on each layer) is 147,924.

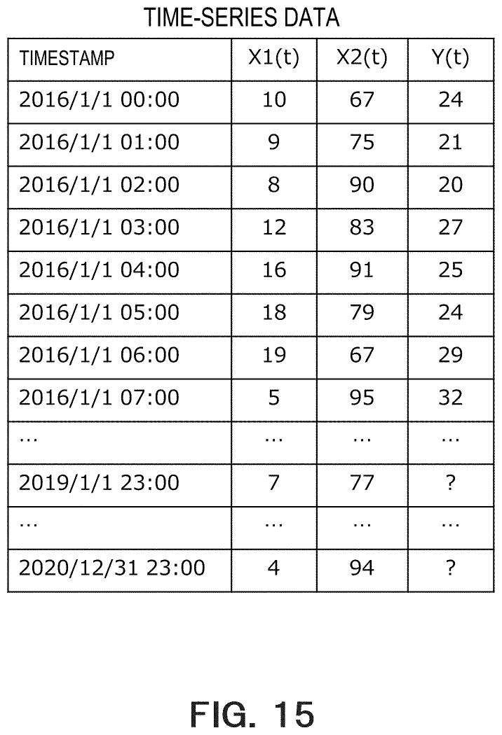

Referring to FIGS. 15, 16 and 17, the specific examples of this embodiment (specific examples 1 and 2) are described.

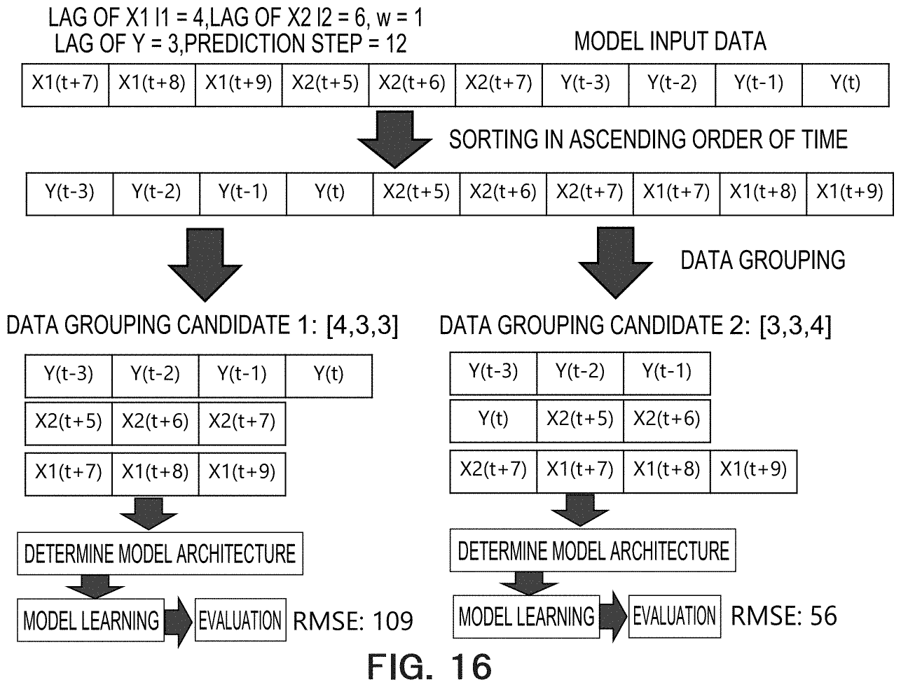

FIG. 15 shows an example of time-series data. The time-series data in FIG. 15 is time-series data that has explanatory variables (X1 and X2) and the objective variable (Y). FIG. 16 shows an example (specific example 1) of determining the model architecture and data grouping, based on the time-series data in FIG. 15. In the specific example 1, an example is described where the time ascending order is used to create the model input data. In the cross-correlation analysis, when the lag (l1) of the explanatory variable X1 is four and the lag (l2) of the explanatory variable X2 is six, the cross-correlation with objective variable “Y” becomes the maximum. The autocorrelation of the objective variable “Y” becomes the maximum, when the lag is three. The prediction step “Δt” is assumed as “12” (in this example, the case of predicting the value of the objective variable 12-hours after the current timestamp “t” is dealt with).

With respect to the explanatory variables (X1 and X2), the window width “w (=1)” is set, for the lag having the maximum cross-correlation, and three data items including the time of this lag, and times before and after the time are adopted. Note that the window width is preset by the user. For the objective variable, data items at the current timestamp “t” to an item before that having the maximum cross-correlation are adopted. In this example, data for four times including the current timestamp “t” is adopted. From the data obtained for each of the explanatory variables and the objective variable, the model input data is created. In this example, the model input data is “X1(t+7), X1(t+8), X1(t+9), X2(t+5), X2(t+6), X2(t+7), Y(t−3), Y(t−2), Y(t−1), and Y(t)”. These variables in the model input data corresponds to the first variables (explanatory variables of the prediction model). As in the example in FIG. 4 and the like described above, the model input data may include the second variable (the objective variable “Y(t+Δt)”of the prediction model).

Next, the model input data is sorted based on the ascending order of the timestamp. After the sorting, the model input data is “Y(t−3), Y(t−2), Y(t−1), Y(t), X2(t+5), X2(t+6), X2(t+7), X1(t+7), X1(t+8), and X1(t+9)”.

Next, the variables (first variables) included in the sorted model input data are grouped in the temporal order, and a plurality of data grouping candidates are generated. In this example, two grouping candidates are generated.

In the grouping candidate 1, four, three and three variables are divided respectively into the first data group, the second data group, and the third data group. As a result, the first data group is “{Y(t−3), Y(t−2), Y(t−1), Y(t)}”, the second data group is “{X2(t+5), X2(t+6), X2(t+7)}”, and the third data group is “{X1(t+7), X1(t+8), X1(t+9)}.

In the grouping candidate 2, three, three and four variables are divided respectively into the first data group, the second data group, the third data group. As a result, the first data group is “{Y(t−3), Y(t−2), Y(t−1)}”, the second data group is “{Y(t), X2(t+5), X2(t+6)}”, and the third data group is “{X2(t+7), X1(t+7), X1(t+8), X1(t+9)}.

For each grouping candidate, a model architecture is determined, model generation and evaluation (in this example, RMSE is calculated as the evaluation score) are performed. A plurality of candidates of the model architecture may be determined for each grouping candidate, the best model architecture may be selected based on the evaluation score. The evaluation score about the grouping candidate 2 is better (smaller) than the evaluation score of the grouping candidate 1. Accordingly, the grouping candidate 2 is selected. The model architecture determined for the grouping candidate 2 is selected as the best model architecture. The prediction model generated from the grouping candidate 2 and the model architecture is selected.

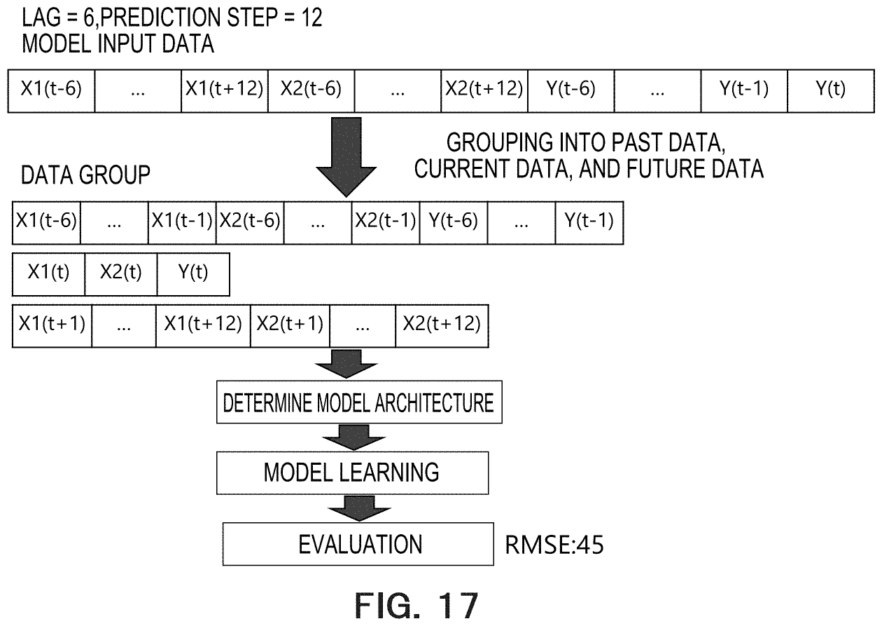

FIG. 17 shows an example (specific example 2) of determining the model architecture and data grouping, based on the time-series data in FIG. 15. An example is described where previous knowledge is used for model input data creation and data grouping. It is assumed that the user sets the lag to six, for each of the explanatory variable “X1”, the explanatory variable “X2” and the objective variable “Y”. It is further assumed that the prediction step “(Δt)” is set to 12. Accordingly, data at the timestamps from “t−6” to “t+12” is adopted as the explanatory variables “X1, X2” from the time-series data, and data at the timestamps “t−6” to “t” is adopted as the objective variable “Y”, and generates the model input data “{X1(t−6), X1(t+12), X2(t−6), X2(t+12), Y(t−6), Y(t−1), Y(t)}”. These variables in the model input data correspond to the first variables (explanatory variables of the prediction model). As in the example in FIG. 4 and the like described above, the model input data may include the second variable (the objective variable “Y(t+Δt)” of the prediction model).

The model input data is divided into three groups that are past data “{X1(t−6), X1(t−1), X2(t−6), X2(t−1), Y(t−6), Y(t−1)}”, current data “{X1(t), X2(t), Y(t)}”, and future data “{X1(t+1), X1(t+12), X2(t+1), X2(t+12)}”. After data grouping, the model architecture is determined, model generation and evaluation (in this example, RMSE is calculated as the evaluation score) are performed. The time “t” corresponds to the first time. Times (from “t−1” to “t−6”) before the time “t” correspond to the second time. Times (from “t+1” to “t+12”) after the time “t” correspond to the third time. The time “t” corresponds to the current time, i.e., a time at a time point when prediction is performed.

A plurality lag candidates may be generated, and the evaluation score may be calculated for each lag candidate. In this case, the evaluation scores are compared between the lag candidates, and the best lag is determined. The data grouping that obtains the best lag is selected.

In this description, the data group divides the data into the three data groups, which are the past, current and future data groups. Alternatively, the best pair of the grouping candidate and the lag candidate may be selected from among the grouping candidates and the lag candidates. A plurality of model architecture candidates may be added, the best pair of the grouping candidate and the lag candidate, and the model architecture candidate may be selected.

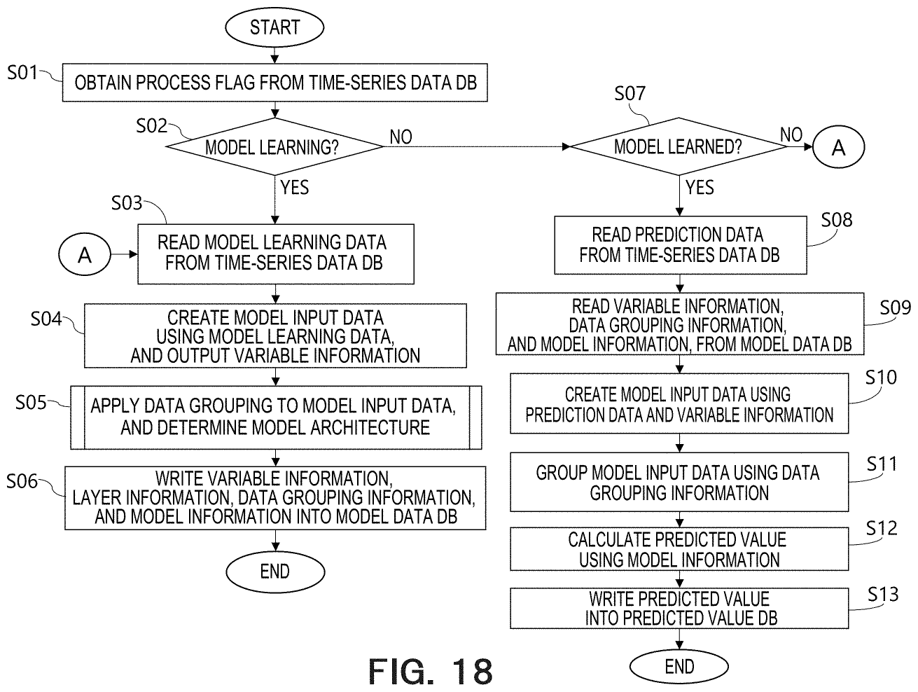

FIG. 18 shows a flowchart of processes to generate the prediction model, and predicting the future values of the objective variable, as an information processing method according to this embodiment. First, the model input data creator 2 obtains a processing flag from the time-series data DB 1 (step S01), and checks whether the process flag indicates the model learning process or the prediction process (step S02).

When the process flag indicates the model learning process (YES in step S02), the model input data creator 2 reads the model learning data from the time-series data DB 1 (step S03).

The model input data creator 2 creates the model input data using the model learning data, and writes variable information that is information about the variables (the first variables and the second variable) included in the model input data, into the model data DB 7 (step S04).

The data grouping device 3 cooperates with the model architecture determiner 4, the model generator 6 and the evaluator 8, groups the first variables included in the model input data, determines the model architecture, generates the prediction model (determines the model parameter) and evaluates the prediction model, and determines the best grouping and the best model architecture (best prediction model) (step S05). Data grouping information that indicates the determined grouping, layer information on the determined model architecture, and information (model information) about the determined prediction model, are obtained. The details of step S05 are described later.

Next, the evaluator 8 writes the variable information, the data grouping information, the layer information, and the model information, into the model data DB 7, and finishes the processing (step S06).

When the process flag indicates the prediction process (NO in step S02), the model input data creator 2 checks whether the prediction model has already been generated, based on the information stored in the model data DB 7 (step S07). If the prediction model has not been generated yet (NO in step S07), the prediction model is generated using steps S03 to S06.

If the prediction model has already been generated (YES in step S07), the model input data creator 2 reads the prediction data from the time-series data DB 1 (step S08).

Next, the model input data creator 2 reads the variable information, the data grouping information, and the model information from the model data DB 7 (step S09).

The model input data creator 2 creates the model input data for prediction, using the prediction data and the variable information (step S10).

The model input data creator 2 groups the variables (first variables) included in the model input data for prediction, using the data group information (step S11).

The predictor 9 calculates the predicted value, using the variables (first variables) of each group, and the prediction model indicated by the model information (step S12). The predictor 9 writes the calculated predicted value, into the predicted value DB 10 (step S13).

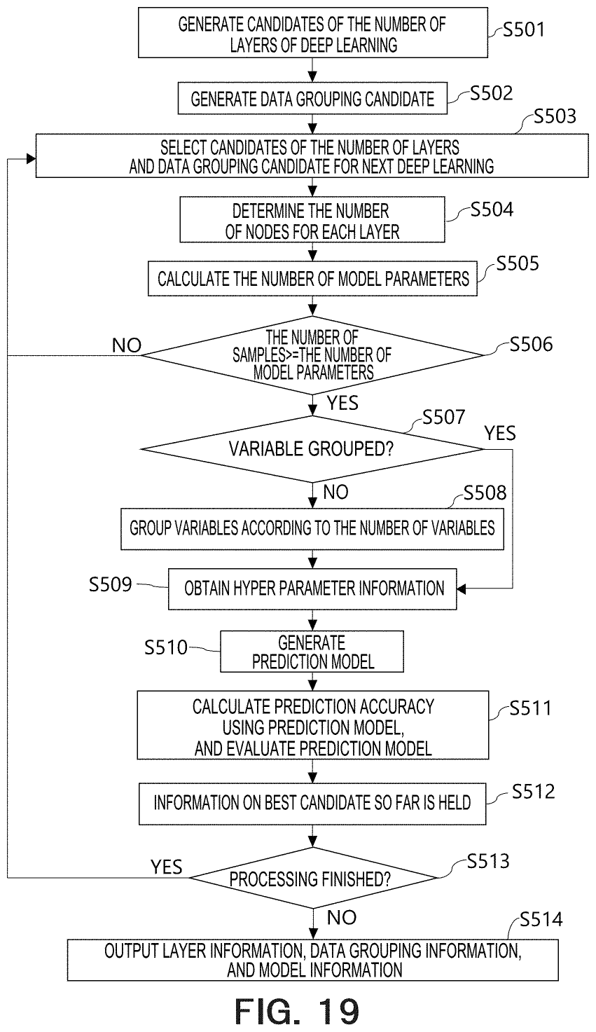

FIG. 19 is a flowchart showing the detailed operation of step S05 in FIG. 18. First, the model architecture determiner 4 determines one or more types of layers to be used for deep learning, and generates the candidates of the number of layers for each type of layers (step S501). For example, LSTM layers and dense layers are determined as the types of layers, and candidates of the numbers of layers, such as “<2, 2>”, “<1, 2>”, “<2, 3>” and “<3, 4>” are generated. In “<a, b>”, “a” is the number of LSTM layers, and “b” is the number of dense layers. The types and numbers of layers are examples of the model architecture. Furthermore, when the model type (linear regression model, deep learning, neural network, etc.) is selectable, the model type may be determined. The model type is also an example of the model architecture.

Next, the data grouping device 3 generates one or more grouping candidates (step S502). The grouping candidates are candidates for grouping that classifies the variables (first variables) of the model input data into data groups. The grouping candidates may be generated using previous knowledge. The grouping candidate may be randomly generated. According to a certain example of creating the grouping candidates, first, the number of data groups may be determined, and subsequently, the variables to be divided into each data group may be determined. For example, the grouping candidates of the variables of the model input data are [5, 5], [4, 6], [3, 3, 4], [2, 3, 5], [4, 2, 4], [1,3,6] . . . . For example, [5, 5] indicates two data groups. Each data group includes five variables. Likewise, the case of [3, 3, 4] indicates three data groups. The data groups respectively include three, three and four variables.

The data grouping device 3 selects the candidate of the numbers of layers and the grouping candidate for next deep learning (next iterative processing) from among the candidates of the numbers of layers and the grouping candidates generated respectively in steps S501 and S502 (step S503).

Next, the model architecture determiner 4 determines the number of nodes for each layer as the value indicated by the selected candidate of the numbers of layers (step S504).

Next, the model architecture determiner 4 calculates the number of model parameters for each layer using the expression described above, and totalizes the parameters on the layers (step S505).

Next, the model architecture determiner 4 checks whether the total number of model parameters is equal to or less than the number of samples of the model input data (step S506). When the total number of model parameters is not equal to or less than the number of samples (NO in step S506), the model architecture determiner 4 instructs the data grouping device 3 to select the next candidate (the pair of the candidate of the numbers of layers and the grouping candidate).

When the number of model parameters is equal to or less than the number of samples (YES in step S506), the data grouping device 3 checks whether the variables have already been grouped (step S507). That is, if the processing returns from step S506 to step S503, or from step S513 to step S503, described later, and the same grouping candidate as the previous grouping candidate is selected, the variables have already been grouped. If the variable has not been grouped (NO in step S507), the data grouping device 3 groups the variables (step S508). In this case, the variables of the model input data are divided into groups, using previous knowledge, or randomly, or in the temporal order.

In the case of division using previous knowledge, for example, the variables (first variables) of the model input data are divided into past data, current data, and future data, which are respectively regarded as the first data group, the second data group, and the third data group. For example, it is assumed that the variables (the first variables and the second variable) of the model input data are “{X1(t−2), X1(t−1), X2(t−2), X2(t−1), Y(t−2), Y(t−1), X1(t), X2(t), Y(t), X1(t+1), X1(t+2), X2(t+1), X2(t+2), Y(t+2)}”. “Y(t+2)” is the second variable (corresponding to the objective variable of the prediction model). The remaining variables are the first variables (corresponding to the explanatory variables of the prediction model). In this case, the first variables are divided into three groups that are “{{X1(t−2), X1(t−1), X2(t−2), X2(t−1), Y(t−2), Y(t−1)}, {X1(t), X2(t), Y(t)}, {X1(t+1), X1(t+2), X2(t+1), X2(t+2)}}”.

In the case of division in the temporal order, when the grouping candidate is [3,3,4], all the variables are arranged in time ascending order in the temporal order. The first three are divided into the first data group, and the next three are divided into the second data group, and the last four are divided into the third data group.

In the case of random division, the first three variables are randomly selected and divided into the first data group, the three variables are randomly selected from among the remaining seven variables and divided into the second data group, and the remaining four variables are divided into the third data group.

If the variables have already been grouped (YES in step S507), the model generator 6 then obtains hyper parameter information on the model from the hyper parameter device 5 (step S509).

The model generator 6 generates (learns) the prediction model, based on the variables of each group, the hyper parameter information, and the architecture (the layer type, the number of nodes on each layer, etc.) (step S510).

The evaluator 8 uses the generated prediction model, calculates the prediction accuracy of the model input data, and calculates the evaluation value (evaluation score and the like) (step S511).

Through iteration of steps S503 to S512, the evaluator 8 holds information on the best grouping candidate and the prediction model (step S512). The information on the model architecture in the prediction model may be held.

Next, the evaluator 8 determines whether to finish the processing, based on whether an end condition is satisfied (step S513). An example of the end condition is a case where the accuracy of the held prediction model is equal to or higher than a threshold (sufficient). Another example of the end condition is a case where preset number of iterations are performed. Still other examples of the end condition are a case where all the candidates of the numbers of layers are selected, a case where all the grouping candidates are selected, and a case where all the pairs of the candidates of the numbers of layers and the grouping candidates are selected. When the end condition is satisfied, it is determined to finish the processing.

When the processing is finished (YES in step S513), the evaluator 8 writes information held in step S512, i.e., the information about the best candidate (the data group information, and the layer information), and the information about the prediction model (model information), into the model data DB 7 (step S514). The information on the model architecture of the prediction model may be written into the model data DB 7.

When the processing is not finished (NO in step S513), the evaluator 8 instructs the data grouping device 3 to select the next candidate.

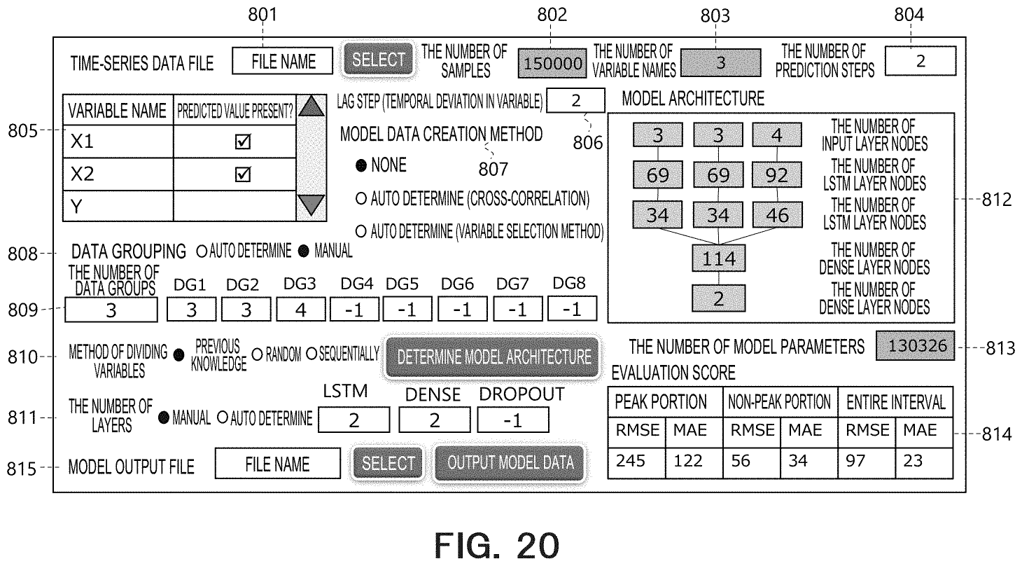

FIG. 20 shows an example of a graphical user interface (GUI), as a function of the evaluator 8, for setting learning conditions, such as a condition of data grouping (first condition) and a model architecture condition (second condition), and for presenting a learning result.

First, the user clicks a selection button at the right of “FILE NAME” field, and selects the time-series data. After the time-series data is selected, the selected file name is stored in the field of the file name (801). The model input data is generated, and the number of samples of the model input data (802), and the numbers of target explanatory variables and objective variables (803) are displayed. Furthermore, a variable table (805) that includes the names of the explanatory variables and the objective variable (variable names), and presence or absence of the predicted value is displayed. In this example, the explanatory variables “X1” and “X2” and the objective variable “Y” are present as time-series data. In each of the explanatory variables “X1” and “X2”, a predicted value is present. The presence of the predicted value means that the value of to time (predicted value) after the current time “t” is present. The explanatory variable includes the current value, past value, and predicted value, for each of “X1” and “X2”. Note that the objective variable “Y” includes the value of the current time, and the value of the past time.

Next, the user inputs the number of prediction steps (804). The number of prediction steps corresponds to the number of objective variable (second variable) of the prediction model, i.e., the number of output variables.

Next, the user inputs the lag (the time lag of the variable) into a lag field (806), and selects model input data (807) from among multiple items. The example in the diagram includes “NONE” “AUTO DETERMINE (CROSS-CORRELATION)”, “AUTO DETERMINE (VARIABLE SELECTION METHOD)”. According to “NONE”, the lags of the explanatory variables and the objective variable are values input in the lag field, and a window width predetermined as the hyper parameter is used, and model input data is created. In cases of “AUTO DETERMINE (CROSS-CORRELATION)” and “AUTO DETERMINE (VARIABLE SELECTION METHOD)”, model input data is created using a predetermined window width, with a value input in the lag field as a constraint of the maximum lag, according to the corresponding algorithm. The window width may be allowed to be designated through this GUI. The parameter (n) may be predetermined as the hyper parameter. Alternatively, the parameter (n) may be allowed to be designated through this GUI.

Next, the user selects whether data grouping (808) is determined by this apparatus, or by the user and input manually. That is, on the screen, any of “AUTO DETERMINE” and “MANUAL” is selected.

When the data group is determined by the user, values are respectively input into text boxes (809) for storing the number of data groups, the number of members of the data groups 1 to 8 (DG1 to DG8). In the example in the diagram, the number of data groups is “3”, and the numbers of members of the data groups 1 to 3 are “3”, “3” and “4”, respectively. Since the number of data groups is “3”, data groups 4 to 8 are absent. A default value “−1” is input as each of the number of members of the data groups 4 to 8.

Next, a method of dividing the variables (first variables) of the model input data (810) is selected. In a case of “PREVIOUS KNOWLEDGE”, the variables of the model input data are divided into the past data group, the current data group, and the future data group. In a case where “RANDOM” is selected, the variables of the model input data are randomly divided into multiple data groups. When “SEQUENTIAL” is selected, all the variables are sorted in time ascending order, and are divided into multiple data groups. Note that in a case of “PREVIOUS KNOWLEDGE”, the number of data groups, and the number of members of each data group may be determined in conformity with the configuration of the model input data, irrespective of the values of the text boxes (809).

Next, the user selects whether the number of layers (811) is determined by this apparatus, or by the user and input manually. In the case of determination by the user, corresponding values are input into the text boxes of “LSTM”, “DENSE” and “DROPOUT”. “−1” means that the layer concerned is not used. In the example in the diagram, “DROPOUT” is not used. Other layer, for example, an RNN layer, a GRU layer, and a CNN layer may be defined.

When the user clicks a model architecture determination button, the data grouping (when “AUTO DETERMINE” is selected) and the model architecture are determined. As information on the determined model architecture (812), the number of nodes on each layer is displayed. The total number of model parameters on each layer (813), and an evaluation score table (814) are also displayed.

The evaluator 8 may classify all the samples into any of classes of a peak portion and a non-peak portion, using the value of the objective variable of the model learning data and a threshold. The samples having the value of the objective variable equal to or higher than the threshold are classified into the peak portion class. The samples having the value less than the threshold are classified into the non-peak portion class. The evaluator 8 calculates the RMSE and MAE for each of the peak portion and non-peak portion classes. The RMSE and MAE of all the samples (entire interval) are also calculated. The evaluation score table (814) includes the RMSE and MAE for each of the peak portion and non-peak portion classes, and the RMSE and MAE of all the samples.

When the evaluation score table (814) is verified by the user and the user accepts the learning result, he or she presses a selection button, and inputs “FILE NAME” at a model output file (815), and presses a model data output button. Accordingly, the layer information on the model architecture (the layer name, and the number of layers), data group information (the number of data groups, a variable list belonging to the data group), and the model information (the model parameter value, the hyper parameter information, etc.) are written into the model data DB 7.

### MODIFIED EXAMPLE

In the embodiment described above, the model input data creator 2 creates the model input data for model learning, and the model input data for prediction, based on the relationship between the explanatory variables and the objective variable. However, in cases where the correlation between variables having the same variable name in the created model input data is high, the accuracy of the generated prediction model sometimes decreases. For example, in the model input data in FIG. 6, the cases include a case where the correlation between “X1(t−1)” and “X1(t−2)” is high, a case where the correlation between “X2(t+1)” and “X2(t−1)” is high, and a case where the correlation between “Y(t−1)” and “Y(t−2)” is high. To solve the problem, with respect to each of the explanatory variables and the objective variable in the time-series data, the model input data creator 2 generates a plurality of temporary variables at different times for each of the same variable names, generates a new variable using the temporary variable, and adopts the generated variable as a first variable to be included in the model input data. For generating the new variable, a function that receives a temporary variable as an input may be used, and the output value of the function may be adopted as the new variable.

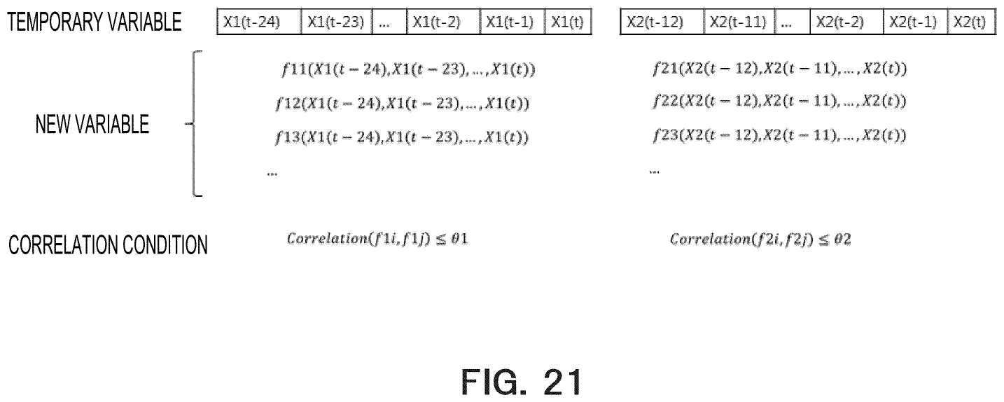

FIG. 21 illustrates an example of the model input data creator 2 creating new variables. For the variable “X1”, temporary variables “X1(t)” to “X1(t−24)” at the respective times from “t” to “t−24” are generated. For the variable “X2”, temporary variables “X2(t)” to “X2(t−12)” at the respective times from “t” to “t−12” are generated. “f11”, “f12”, “f13” . . . are prepared as functions for the variable “X1”. “f21”, “f22”, “f23” . . . are prepared as functions for the variable “X2”. “f11” and “f21” are functions of calculating the total sum of the logarithms of the temporary variables. “f12” and “f22” are functions of calculating the total sum of the temporary variables. “f13” and “f23” are functions of calculating the total sum of the sine functions of the temporary variables.

Accordingly, in this example,

f11=log(X1(t−24))+log(X1(t−23))+ . . . +log(X1(t)),

f21=log(X2(t−12))+log(X2(t−11))+ . . . +log(X2(t)),

f12=SUM(X1(t−24), X1(t−23), . . . , X1(t)),

f22=SUM(X2(t−12), X2(t−11), . . . , X2(t)),

f13=SUM(sin X1(t−24), sin X1(t−23), . . . , sin X1(t)), and

f23=SUM(sin X2(t−12), sin X2(t−11), . . . , sin X2(t))

are calculated as new variables.

In this example, the example with the three functions is described. However, new variables may be generated using other functions. For “X1”, the times for the input variables are described as “t” to “t−24”. However, two or more times may be combined, and multiple new variables may be generated. For example, new variables may be additionally generated as follows. f14=log(X1(t−24))+log(X1(t−22))+log(X1(t−20))+ . . . log(X1(t−2)), f15=log(X1(t−23))+log(X1(t−21))+ . . . log(X1(t−3))+log(X1(t)), f16=SUM(X1(t−11), X1(t−7), X1(t−5), X1(t−3), X1(t)), and f17=SUM(sin X1(t−4), sin X1(t−3), sin X1(t−2), sin X1(t−1), sin X1(t)). This similarly applies to X2.

A requirement may be that the correlation between new variables is equal to or less than a threshold “θ” (correlation condition). That is, a requirement may be that “Correlation(f1i, f1j)<=θ1” and “Correlation(f2i, f2j)<=θ2” are satisfied. “Correlation(f1i, f1j)” is the correlation coefficient between the output value “f1i” (new variable) of a function and output value “f1j” (new variable) of a function. “θ1” and “θ2” are thresholds. “θ1” and “θ2” may have the same value. In this case, for example, all the pairs of the new variables are generated, and the correlation coefficient is calculated for each pair. Only the new variable having the correlation coefficient equal to or less than “θ” with any new variable is finally adopted.

In this example, the example where the new variables are generated for “X1” and “X2” is described. New variables may be similarly generated also to “Y”.

In the example in FIG. 21, the new variables are generated using the predefined function. Alternatively, the new variables may be generated by another method. For example, the new variables can be generated using genetic programming (genetic algorithm).

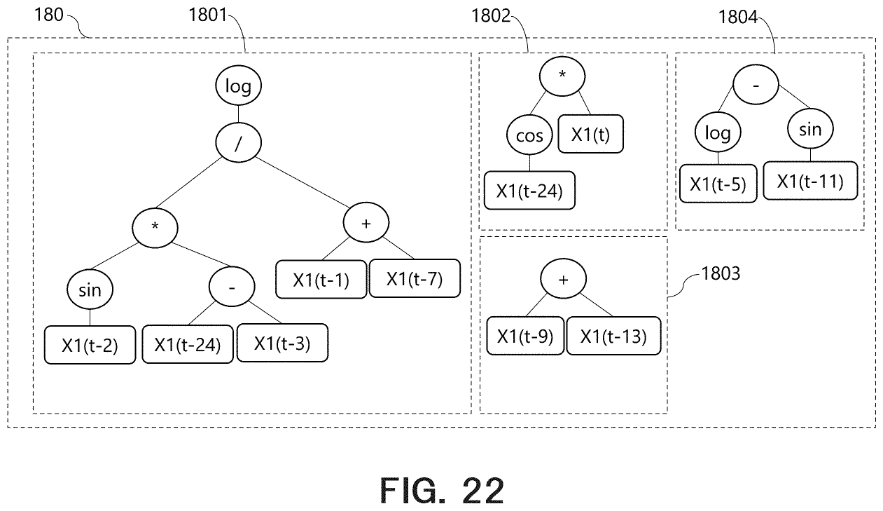

FIG. 22 shows an example of generating new variables using genetic programming. In the case of using genetic programming, any number of variables can be selected. The function for generating the new variables are automatically learned. In the example in FIG. 22, as a result of learning through genetic programming, an individual solution tree structure 180 are generated. The individual solution tree structure 180 holds tree structures 1801, 1802, 1803 and 1804 of four functions. The functions represented by the tree structures 1801, 1802, 1803 and 1804 are as follows.

f11=log(sin(X1(t−2))*(X1(t−24)−X1(t−3))/(X1(t−1)+X1(t−7)))

f12=cos(X1(t−24))*X1(t)

f13=X1(t−9)+X1(t−13)

f14=log(X1(t−5))−sin(X1(t−11))

In genetic programming, first, from the temporary model input data and an operator list “{+, −, /, *, log, sin, cos, tan, . . . }”, variables and operators are randomly selected, and a list including initial individual solutions is created. Each initial individual solution includes a plurality of functions (tree structures) that include the randomly selected operators and variables. That is, on this list, the individual solution tree structure similar to that in FIG. 22 is adopted as an element, and the list includes a plurality of the elements. The correlation coefficient between functions included in the initial individual solution is calculated, and the fitness of the initial individual solution is calculated. For example, the correlation coefficient is calculated for every pair of functions included in the initial individual solution, and the fitness is calculated, based on the average, the maximum value or minimum value of correlation coefficients. The lower fitness means that the initial individual solution is better.

Next, some individual solutions (initial individual solution) are selected from the initial individual solution list according to the fitness, and the crossover and mutation are applied to the selected individual solution, thereby generating a new individual solution. Next, the fitness is calculated for the new individual solution. A plurality of individual solutions are selected from the individual solutions included in the individual solution list (the initial individual solution list at the first time) used in the last iterative process, and the new individual solutions. An individual solution list for the next iterative process including the selected individual solutions is generated. Until the end condition (e.g., the number of iterations) is satisfied, selection of the individual solution, crossover and mutation processing, and creation of the individual solution list for the next iterative process are sequentially performed and repeated. Lastly, in the individual solution list, a plurality of individual solutions having the fitness equal to or less than the threshold are selected, and the functions are generated from the respective tree structures included in the selected individual solution. The individual solution shown in the example in FIG. 22 corresponds to one of the selected individual solutions. Based on the tree structures 1801 to 1804 included in the individual solution tree structure 180 shown in FIG. 22, the functions “fl1” to “fl1” are generated.

### APPLIED EXAMPLE

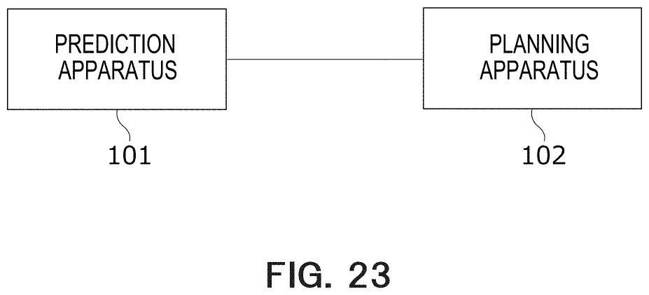

FIG. 23 shows an information processing apparatus according to this embodiment. The information processing apparatus in FIG. 23 includes an information processing apparatus (prediction apparatus) 101 according to this embodiment, and a planning apparatus (planner) 102. The prediction apparatus 101 and the planning apparatus 102 can be wiredly or wirelessly communicate with each other. The planning apparatus 102 may be implemented in the prediction apparatus 101.

In this example, the prediction apparatus 101 predicts the objective variable related to the storage capacity for the hydroelectric power plant. For example, the objective variable is the inflow and the water level of a dam, the water level of a river, etc. The explanatory variable may be the weather data (weather, precipitation, temperature, etc.). The prediction apparatus 101 provides the predicted value of the predicted objective variable for the planning apparatus 102. The planning apparatus 102 generates a power generation plan, based on the predicted value of the future objective variable. For example, a power generation plan that accommodates the water level of the dam within a constant range is generated. If it is predicted that insufficient future precipitation reduces the water level, and a desired power generation cannot be obtained, control may be made so that through demand control through demand response or the like, consumers are requested to save power. The method of planning power generation is not limited to a specific method. Only if the output result of the prediction apparatus 101 is used, any method may be adopted. For example, shortage of power generation is predicted, power generation with pumped-up water may be additionally executed. The shortage of power generation may be notified to another power generation plant, such as a atomic energy power plant.

At least some configuration elements of the prediction apparatus according to the embodiment described above may be configured into a chip. At least some of the configuration elements of the prediction apparatus according to the embodiment may be implemented in SoC (System on Chip), such as an edge device. In this case, at least one of the time-series data DB, the predicted value DB, and the model data DB may be provided out of SoC, and may be allowed to be accessible via a predetermined interface device. At least a part of the prediction apparatus described in the aforementioned embodiment may be configured as hardware or as software. In the case of the configuration as software, a computer program that achieves at least a part of the function of the prediction apparatus may be stored in a record medium, such as a flexible disk or a CD-ROM, and be read by a computer that includes a processor, and be executed. The record medium is not limited to a detachable one, such as a magnetic disk or an optical disk, and may be a fixed type record medium, such as a hard disk device or a memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing apparatus, comprising:
processing circuitry configured to group first variables in first data that includes the first variables and a second variable, and generate a plurality of groups that include the first variables; and
determine a model architecture of a prediction model, based on the first data, the prediction model being configured to associate the first variables included in the groups with a predicted value of the second variable.

2. The information processing apparatus according to claim 1, wherein
the processing circuitry is configured to calculate an evaluation value of the prediction model, based on a difference between the predicted value of the second variable and a value of the second variable in the first data,
wherein the processing circuitry is configured to apply grouping to the first variables, based on the evaluation value.

3. The information processing apparatus according to claim 2,
wherein the processing circuitry is configured to generate a plurality of grouping candidates for grouping the first variables, and
the processing circuitry is configured to group the first variables, based on a grouping candidate selected from among the grouping candidates, based on the evaluation value.

4. The information processing apparatus according to claim 2,
wherein the processing circuitry is configured to determine the model architecture, based on the evaluation value.

5. The information processing apparatus according to claim 1, wherein the processing circuitry is configured to generate the prediction model, based on the model architecture determined by the determiner.

6. The information processing apparatus according to claim 1,
wherein the prediction model includes a plurality of sub-models that receive, as inputs, the first variables of the groups, and the prediction model is a model for prediction of the second variable, based on an output value of the sub-models.

7. The information processing apparatus according to claim 1,
wherein the first variables are respectively associated with a plurality of times, and
the processing circuitry is configured to apply grouping to the first variables in an order according to the times.

8. The information processing apparatus according to claim 1,
wherein the first variables include a variable at a first time, a variable at a second time before the first time, and a variable at a third time after the first time, and
the processing circuitry is configured to divide the variable at the first time into a first group, divide the variable at the second time into a second group, and divide the variable at the third time into a third group.

9. The information processing apparatus according to claim 8,
wherein the first time corresponds to a time at when prediction through the prediction model is performed.

10. The information processing apparatus according to claim 1,
wherein the processing circuitry is configured to randomly group the first variables.

11. The information processing apparatus according to claim 1,
wherein the prediction model is a neural network that includes an input layer, at least one intermediate layer, and an output layer, and
the processing circuitry is configured to determine the number of nodes on the at least one intermediate layer, as the model architecture.

12. The information processing apparatus according to claim 1,
wherein the processing circuitry is configured to determine the number of layers of the at least one layers as the model architecture.

13. The information processing apparatus according to claim 1,
wherein the processing circuitry is configured to determine the model architecture having the number of model parameters of the prediction model equal to or less than the number of samples in the first data.

14. The information processing apparatus according to claim 1, wherein
the processing circuitry is configured to calculate a cross-correlation between one or more explanatory variables and an objective variable, with respect to time-series data including the one or more explanatory variables, and time-series data including the objective variable, and create the first data, based on the cross-correlation,
the second variable in the first data includes the objective variable at a prediction target time, and
the first variables in the first data include the explanatory variables at respective times before the prediction target time according to the cross-correlation.

15. The information processing apparatus according to claim 14,
wherein the processing circuitry is configured to calculate an autocorrelation of the objective variable, and
the first variables in the first data include the objective variable at a time before the prediction target time according to the autocorrelation.

16. The information processing apparatus according to claim 1, wherein the processing circuitry is configured to obtain a regression of an objective variable at a prediction target time against one or more explanatory variables at times before the prediction target time with respect to time-series data including the one or more explanatory variables and time-series data including the objective variable, calculate coefficients of the explanatory variables at the times, and select the explanatory variables at times from among the explanatory variables at the times, based on the coefficients, and
create the first data by selecting the explanatory variables at selected times as the first variables of the first data, and selecting the objective variable at the prediction target time as the second variable of the first data.

17. The information processing apparatus according to claim 15,
wherein the processing circuitry is configured to combine the one or more explanatory variables at the times in the time-series data on the explanatory variables, the objective variables at the times in the time-series data on the objective variables, and at least one operator, based on a genetic programming, to create the first variables.

18. The information processing apparatus according to claim 5,
wherein the processing circuitry is configured to assign a weight to the first data, based on a value of the second variable in the first data, and generate the prediction model, based on the weight.

19. The information processing apparatus according to claim 18,
wherein the processing circuitry is configured to assign a first weight to the first data when the second variable has a value corresponding to a peak portion, and assign a second weight to the first data when the second variable has a value corresponding to a non-peak portion, the second weight being smaller than the first weight.

20. The information processing apparatus according to claim 2, further comprising a graphical user interface circuit that sets a first condition on the grouping, and a second condition on the model architecture,
wherein the processing circuitry is configured to apply the grouping, based on the first condition, and
the processing circuitry is configured to determine the model architecture, based on the second condition.

21. An information processing method, comprising:
grouping first variables in first data that includes the first variables and a second variable, and generate a plurality of groups that include the first variables; and
determining a model architecture of a prediction model, based on the first data, the prediction model being configured to associate the first variables included in the groups with a predicted value of the second variable.

22. A non-transitory computer readable medium having a computer program stored therein which causes a computer to perform processes, comprising:
grouping first variables in first data that includes the first variables and a second variable, and generate a plurality of groups that include the first variables; and
determining a model architecture of a prediction model, based on the first data, the prediction model being configured to associate the first variables included in the groups with a predicted value of the second variable.
